(19) United States
(12) Patent Application Publication
(10) Pub. No.: US 2007/0034318 A1
(43) Pub. Date: Feb. 15, 2007

(54) Pneumatic radial tire production method and belt tread assembly transfer apparatus used for the same

(76) Inventors: Ryoji Hanada, Kanagawa (JP); Souichirou Shirato, Kanagawa (JP)

Correspondence Address: GREER, BURNS & CRAIN, 300 S WACKER DR, 25TH FLOOR, CHICAGO, IL, 60606, US

(21) Appl. No.: 10/577,638

(22) PCT Filed: Nov. 22, 2004
(86) PCT No.: PCT/JP04/17349

§ 371 Date: Apr. 28, 2006

(30) Foreign Application Priority Data
Nov. 25, 2003 (JP) 2003-394299

(51) Int. Cl. B29D 30/08

(52) U.S. Cl. 156/126; 156/406.2

(57) ABSTRACT

Provided are a pneumatic radial tire production method which enables to improve uniformity of a tire and also to prevent a separation failure caused by trapped air, and a belt tread assembly transfer apparatus used for the method. A pneumatic radial tire production method includes the steps of forming a primary green tire including a carcass layer; forming a cylindrical belt tread assembly including belt layers; transferring the belt tread assembly to the outer peripheral side of the primary green tire by use of a transfer apparatus; and pressure-bonding the belt tread assembly to the primary green tire inflated in a toroidal shape. In the method, the primary green tire and the belt tread assembly are pressure-bonded to each other in a state where the transfer apparatus allows a center portion of the belt tread assembly to swell while holding both sides of the belt tread assembly.

### TECHNICAL FIELD

The present invention relates to a pneumatic radial tire production method by which a cylindrical belt tread assembly is pressure-bonded to a primary green tire inflated in a toroidal shape. More particularly, the present invention relates to a pneumatic radial tire production method which enables to improve uniformity of a tire and to prevent a separation failure caused by trapped air, and a belt tread assembly transfer apparatus used for the method.

### BACKGROUND ART

In producing a pneumatic radial tire, while a primary green tire including a carcass layer is formed; a cylindrical belt tread assembly including belt layers is formed; the belt tread assembly is transferred to the outer peripheral side of the primary green tire by use of a transfer apparatus; and the belt tread assembly is pressure-bonded to the primary green tire inflated in a toroidal shape (for example, see Patent Document 1).

The transfer apparatus described above has a plurality of holding members which hold the belt tread assembly from the outer peripheral side. The respective holding members have holding surfaces parallel to an axial direction of the belt tread assembly. The holding members hold the cylindrical belt tread assembly in a state where the holding members are in close contact with an outer peripheral surface of the assembly. The primary green tire is inflated in a state where the belt tread assembly is held by use of the transfer apparatus as described above, and the primary green tire and the belt tread assembly are pressure-bonded to each other. Thereafter, the transfer apparatus is moved and stitching is performed for the belt tread assembly. Thus, a secondary green tire is completed.

However, in the case where the primary green tire and the belt tread assembly are pressure-bonded to each other in the state where the belt tread assembly is held by use of the transfer apparatus having flat holding surfaces, a tread shape of the completed secondary green tire is parallel to a tire axial direction immediately after the completion thereof However, the tread shape is deformed so as to gradually sink inward in a tire radial direction. Thus, an increased difference between the shape of the secondary green tire and a mold shape adversely affects uniformity of the tire.

Moreover, in a conventional pneumatic radial tire production method, when a cylindrical belt tread assembly is pressure-bonded to a toroidal primary green tire, it is difficult to tuck in both ends of laminated belt layers toward the primary green tire. As a result, in a vulcanized product tire, trapped air is likely to remain, particularly, between the both ends of the belt layers and the carcass layer. Thus, a separation failure, a so-called blister failure, may occur.

Patent Document 1: Japanese patent application Kokai publication No. Hei 11 (1999)-333945

### SUMMARY OF THE INVENTION

It is an object of the present invention to provide a pneumatic radial tire production method which enables to improve uniformity of a tire and also to prevent a separation failure caused by trapped air, and a belt tread assembly transfer apparatus used for the method.

A pneumatic radial tire production method of the present invention to achieve the foregoing object is a pneumatic radial tire production method including the steps of forming a primary green tire including a carcass layer; forming a cylindrical belt tread assembly including belt layers; transferring the belt tread assembly to the outer peripheral side of the primary green tire by use of a transfer apparatus; and pressure-bonding the belt tread assembly to the primary green tire inflated in a toroidal shape. In the method, the primary green tire and the belt tread assembly are pressure-bonded to each other in a state where the transfer apparatus allows a center portion of the belt tread assembly to swell while holding both sides of the belt tread assembly.

Here, as the belt tread assembly transfer apparatus, it is preferable to use the following two kinds of transfer apparatuses. Specifically, a first transfer apparatus is a transfer apparatus for transferring a belt tread assembly, which includes a plurality of holding members for holding the belt tread assembly from an outer peripheral side. In addition, such curvature as to reduce an inside diameter toward outside in a width direction of the belt tread assembly is given to holding surfaces of the respective holding members. Moreover, a second transfer apparatus is a transfer apparatus for transferring a belt tread assembly, which includes a plurality of holding members for holding the belt tread assembly from an outer peripheral side. In addition, holding surfaces of the respective holding members are divided in a width direction of the belt tread assembly.

In the present invention, the primary green tire and the belt tread assembly are pressure-bonded to each other in a state where the transfer apparatus allows a center portion of the belt tread assembly to swell while holding both sides of the belt tread assembly. Accordingly, a shape of a secondary green tire is approximated to a mold shape. Thus, uniformity of the tire can be improved.

Moreover, when the cylindrical belt tread assembly is pressure-bonded to the toroidal primary green tire, both ends of laminated belt layers are tucked in toward the primary green tire. Accordingly, air is hardly trapped between the both ends of the belt layers and the carcass layer. Thus, it is possible to effectively prevent a separation failure caused by trapped air.

In the case where the transfer apparatus described above has a structure in which the curvature is given to the holding surfaces of the respective holding members, it is preferable that braces be provided on the holding surfaces in the transfer apparatus, in order to prevent the belt tread assembly held by the holding members from moving.

Meanwhile, in the case where the transfer apparatus described above has a structure in which the holding surfaces of the respective holding members are divided in the width direction of the belt tread assembly, it is preferable that a width of each of the divided holding surfaces of each holding member is set to 5 to 30% of a width of the innermost laminated belt layer, in order to effectively prevent the separation failure caused by the trapped air without impairing workability in pressure-bonding.

### BRIEF DESCRIPTION OF THE DRAWINGS

FIG. 1 is a front view schematically showing a belt tread assembly transfer apparatus used in the present invention.

FIG. 2 is a meridian half sectional view showing a pneumatic radial tire production method according to a first embodiment of the present invention.

FIG. 3 is a meridian half sectional view showing a pneumatic radial tire production method according to a second embodiment of the present invention.

FIG. 4 is a meridian half sectional view showing a pneumatic radial tire production method according to a third embodiment of the present invention.

### DESCRIPTION OF THE PREFERRED EMBODIMENTS

With reference to the accompanying drawings, a configuration of the present invention will be described in detail below.

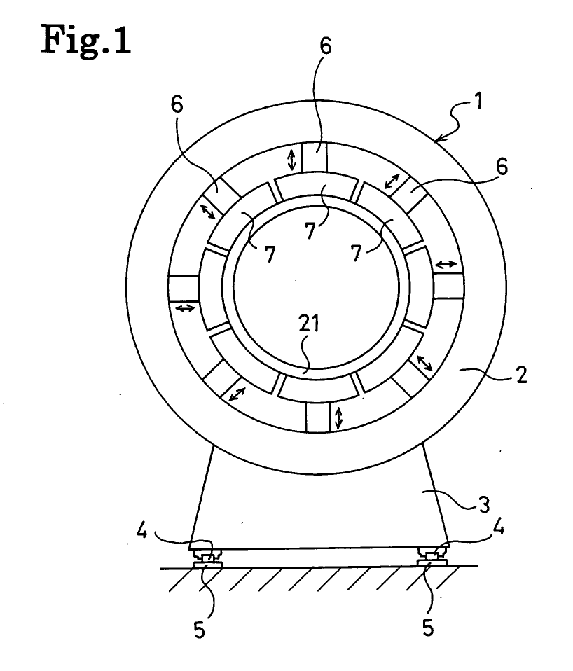

FIG. 1 schematically shows a belt tread assembly transfer apparatus used in the present invention. As shown in FIG. 1, the transfer apparatus 1 has a configuration in which a ring-shaped frame part 2 is mounted on a truck 3, and runs on rails 5 with a plurality of wheels 4 attached to the truck 3. In the frame part 2, a plurality of radially retractable arm members 6 are provided at even intervals in a circumferential direction. Moreover, holding members 7 are attached to tips of the arm members 6, respectively. The plurality of holding members 7 hold a cylindrical belt tread assembly 21 from an outer peripheral side when the arm members 6 are extended inward in the radial direction of the frame part 2.

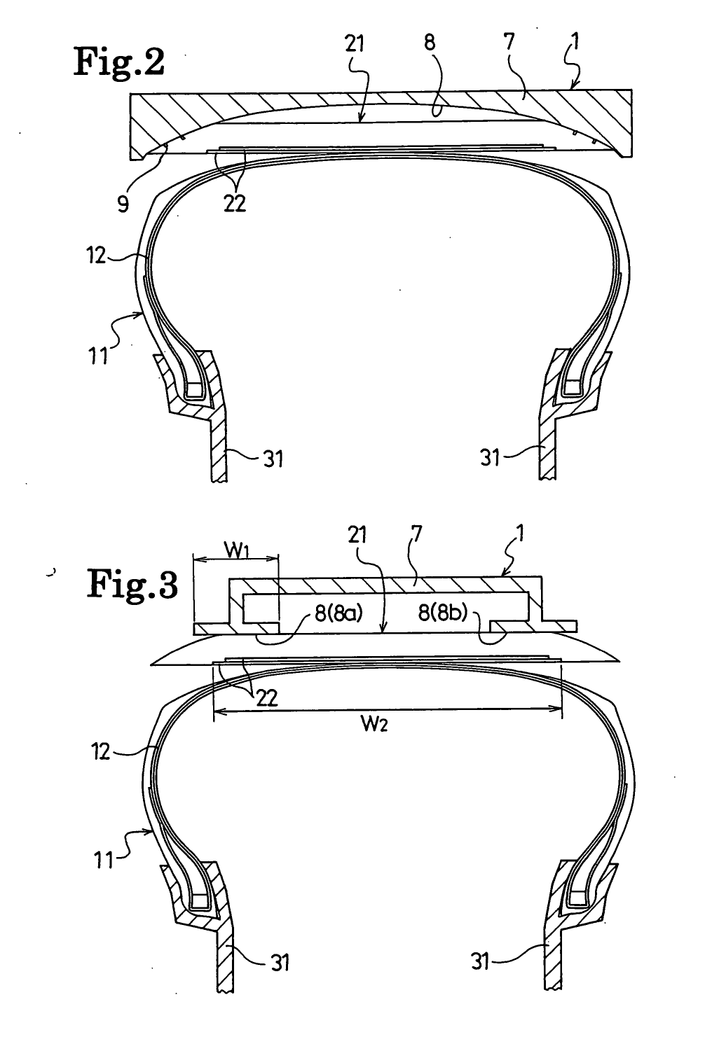

FIG. 2 shows a pneumatic radial tire production method according to a first embodiment of the present invention. In FIG. 2, the holding member 7 of the transfer apparatus 1 has a structure in which such curvature as to reduce an inside diameter toward outside in a width direction of the belt tread assembly 21 is given to a holding surface 8. Thus, the holding member 7 holds the belt tread assembly 21 in a state where the member comes into contact with both sides of the belt tread assembly 21 but never comes into contact with a center portion.

In the case where a pneumatic radial tire is produced by use of the transfer apparatus described above, first, a primary green tire 11 including a carcass layer 12 is formed, and the cylindrical belt tread assembly 21 including belt layers 22 is formed (see FIG. 2). Next, by use of the transfer apparatus 1, the belt tread assembly 21 is transferred to an outer peripheral side of the primary green tire 11 supported by a pair of bead supporting members 31. Thereafter, the belt tread assembly 21 is pressure-bonded to the primary green tire 11 inflated in a toroidal shape by reducing the mutual space between the bead supporting members 31. In this event, the belt tread assembly 21 is held on both ends thereof by the holding member 7 having the curved holding surface 8. Thus, the primary green tire 11 and the belt tread assembly 21 can be pressure-bonded to each other in a state where the transfer apparatus 1 allows a center portion of the belt tread assembly 21 to swell while holding both sides of the belt tread assembly 21. A secondary green tire thus obtained becomes a product tire through a vulcanization step. In the vulcanization step, a shape of the secondary green tire is approximated to a mold shape. Thus, uniformity of the tire can be improved.

Moreover, when the cylindrical belt tread assembly 21 is pressure-bonded to the toroidal primary green tire 11, both ends of the laminated belt layers 22 are tucked in toward the primary green tire 11. Accordingly, air is hardly trapped between the both ends of the belt layers 22 and the carcass layer 12. Thus, it is possible to effectively prevent a separation failure caused by trapped air.

In the case where, as described above, the transfer apparatus 1 has the structure in which the curvature is given to the holding surface 8 of each holding member 7, a brace formed of minute protrusions 9 may be provided, for example, on the holding surface 8 of the transfer apparatus 1, in order to prevent the belt tread assembly 21 held by the holding member 7 from moving. As the brace, it is possible to perform roughing of the holding surface 8 or to form the holding surface 8 by use of rubber, other than to provide the minute protrusions 9 on the holding surface 8.

FIG. 3 shows a pneumatic radial tire production method according to a second embodiment of the present invention. In FIG. 3, a holding member 7 of a transfer apparatus 1 has a structure in which a holding surface 8 thereof is divided in a width direction of a belt tread assembly 21. Specifically, the holding member 7 has a bridge structure in which the member strides over the belt tread assembly 21 in its width direction while dividing the holding surface 8 into a holding surface 8a and a holding surface 8b. Between the holding surfaces 8a and 8b, a space is provided. Thus, the holding member 7 holds the belt tread assembly 21 in a state where the member comes into contact with both sides of the belt tread assembly 21 but never comes into contact with a center portion.

In the case where a pneumatic radial tire is produced by use of the transfer apparatus described above, first, a primary green tire 11 including a carcass layer 12 is formed, and the cylindrical belt tread assembly 21 including belt layers 22 is formed (see FIG. 3). Next, by use of the transfer apparatus 1, the belt tread assembly 21 is transferred to an outer peripheral side of the primary green tire 11 supported by a pair of bead supporting members 31. Thereafter, the belt tread assembly 21 is pressure-bonded to the primary green tire 11 inflated in a toroidal shape by reducing the mutual space between the bead supporting members 31. In this event, the belt tread assembly 21 is held on only both ends thereof by the holding member 7 having the divided holding surfaces 8a and 8b. Thus, the primary green tire 11 and the belt tread assembly 21 can be pressure-bonded to each other in a state where the transfer apparatus 1 allows a center portion of the belt tread assembly 21 to swell while holding both sides of the belt tread assembly 21. A secondary green tire thus obtained becomes a product tire through a vulcanization step. In the vulcanization step, a shape of the secondary green tire is approximated to a mold shape. Thus, uniformity of the tire can be improved.

Moreover, when the cylindrical belt tread assembly 21 is pressure-bonded to the toroidal primary green tire 11, both ends of the laminated belt layers 22 are tucked in toward the primary green tire 11. Accordingly, air is hardly trapped between the both ends of the belt layers 22 and the carcass layer 12. Thus, it is possible to effectively prevent a separation failure caused by trapped air.

In the case where, as described above, the transfer apparatus 1 has the structure in which the holding surface 8 of each holding member 7 is divided in the width direction of the belt tread assembly 21, a width W₁ of each of the divided holding surfaces 8a and 8b of each holding member 7 may be set to 5 to 30% of a width W₂ of the innermost laminated belt layer 22, in order to effectively prevent the separation failure caused by the trapped air without impairing workability in pressure-bonding. If the width W₁ is less than 5% of the width W₂, it becomes difficult to perform the operation of pressure-bonding the primary green tire 11 and the belt tread assembly 21 to each other. On the other hand, if the width W₁ exceeds 30% of the width W₂, the effect of preventing the separation failure caused by the trapped air is reduced.

Note that, if the transfer apparatus is configured in such a manner that the space between the holding surfaces 8a and 8b can be freely changed in the holding member 7, it is made possible to support various tire sizes. In this case, it is not required to prepare a dedicated transfer apparatus for every tire size.

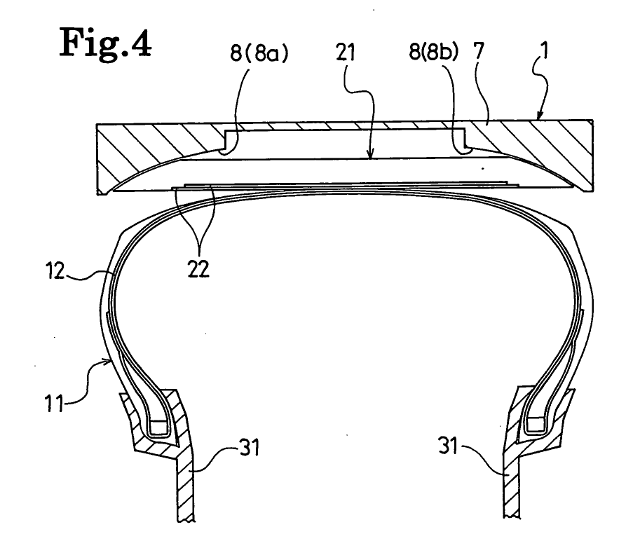

FIG. 4 shows a pneumatic radial tire production method according to a third embodiment of the present invention. This embodiment is a combination of the first and second embodiments. In FIG. 4, a holding member 7 of a transfer apparatus 1 has a structure in which a holding surface 8 thereof is divided in a width direction of a belt tread assembly 21. Specifically, the holding surface 8 is divided into a holding surface 8a and a holding surface 8b, and a space is provided between the holding surfaces 8a and 8b. Furthermore, such curvature as to reduce an inside diameter toward outside in the width direction of the belt tread assembly 21 is given to the holding surfaces 8a and 8b. In the case of using the transfer apparatus 1 as described above, the effects described above can also be obtained.

Although the embodiments of the present invention have been described in detail above, it should be understood that various changes, alternatives, and substitutions can be made without departing from the spirit and scope of the present invention, which are defined by the attached claims.

### EXAMPLES

In production of a pneumatic radial tire (tire size: 225/50R16) which includes two carcass layers made of polyester codes, two belt layers made of steel codes and a belt cover layer made of a nylon code, a primary green tire including the carcass layers is formed, and a cylindrical belt tread assembly including the belt layers is formed. Thereafter, the belt tread assembly is transferred to an outer peripheral side of the primary green tire by use of various transfer apparatuses. Subsequently, the belt tread assembly is pressure-bonded to the primary green tire inflated in a toroidal shape (Examples 1 and 2 and Conventional Example).

In Example 1, as shown in FIG. 4, used is a transfer apparatus having a structure in which curvature (curvature radius: 600 mm) is given to a holding surface of a holding member and the holding surface is divided in a width direction of the belt tread assembly. In Example 2, a rough-surfaced sheet is attached to the holding surface in the transfer apparatus used in Example 1. In Conventional Example, used is a transfer apparatus in which a holding member has a holding surface parallel to an axial direction of the belt tread assembly.

In the above-described tire production methods of Examples 1 and 2 and Conventional Example, 100 pneumatic radial tires are produced, respectively. Thereafter, uniformity is evaluated under the following conditions, and the number of tires in which blister failures occur is checked. Table 1 shows the results.

Uniformity:

For test tires, radial force variation (RFV) measurement was performed under conditions including a measuring load of 4.7 kN, a rim size of 7 JJ×16 and an air pressure of 200 kPa according to JASO C607-87. Thus, an average value of RFV was obtained for the 100 tires. The evaluation results are indicated by indices while setting Conventional Example to 100. A smaller index means better uniformity.

TABLE 1

| | Conventional | | |
|---|---|---|---|
| | Example | Example 1 | Example 2 |
| RFV (uniformity) | 100 | 96 | 90 |
| Number of tires | 4 | 0 | 0 |
| in which blister | | | |
| failures occurred | | | |

As is clear from Table 1, the tires obtained by use of the tire production methods of Examples 1 and 2 had better uniformity than the tires obtained by use of the tire production method of Conventional Example by comparison. Moreover, in the tire production method of Conventional Example, blister failures occurred in 4 tires. On the other hand, in the tire production methods of Examples 1 and 2, no blister failures occurred.

What is claimed is:

1. A pneumatic radial tire production method comprising the steps of:
forming a primary green tire including carcass layer;
forming a cylindrical belt tread assembly including belt layers;
transferring the belt tread assembly to the outer peripheral side of the primary green tire by use of a transfer apparatus; and
pressure-bonding the belt tread assembly to the primary green tire inflated in a toroidal shape,
wherein the primary green tire and the belt tread assembly are pressure-bonded to each other in a state where the transfer apparatus allows a center portion of the belt tread assembly to swell while holding both sides of the belt tread assembly.

2. The pneumatic radial tire production method according to claim 1, wherein the transfer apparatus includes a plurality of holding members which hold the belt tread assembly from an outer peripheral side, and has a structure in which such curvature as to reduce an inside diameter toward outside in a width direction of the belt tread assembly is given to holding surfaces of the respective holding members.

3. The pneumatic radial tire production method according to claim 2, wherein braces are provided on the holding surfaces of the respective holding members.

4. The pneumatic radial tire production method according to claim 1, wherein the transfer apparatus includes a plurality of holding members which hold the belt tread assembly from an outer peripheral side, and has a structure in which holding surfaces of the respective holding members are divided in a width direction of the belt tread assembly.

5. The pneumatic radial tire production method according to claim 4, wherein a width of each of the divided holding surfaces of each holding member is set to 5 to 30% of a width of the innermost laminated belt layer.

6. A belt tread assembly transfer apparatus for transferring a belt tread assembly, comprising:
a plurality of holding members for holding the belt tread assembly from an outer peripheral side,
wherein such curvature as to reduce an inside diameter toward outside in a width direction of the belt tread assembly is given to holding surfaces of the respective holding members.

7. The belt tread assembly transfer apparatus according to claim 6, wherein braces are provided on the holding surfaces of the respective holding members.

8. A belt tread assembly transfer apparatus for transferring a belt tread assembly, comprising:
a plurality of holding members for holding the belt tread assembly from an outer peripheral side,
wherein holding surfaces of the respective holding members are divided in a width direction of the belt tread assembly.

9. The belt tread assembly transfer apparatus according to claim 8, wherein a width of each of the divided holding surfaces of each holding member is set to 5 to 30% of a width of the innermost laminated belt layer.
